(19) United States
(12) Patent Application Publication
(10) Pub. No.: US 2009/0136322 A1
(43) Pub. Date: May 28, 2009

(54) METHOD FOR THERMALLY BINDING A BUNDLE OF LOOSE LEAVES AND BINDING ELEMENT APPLIED THEREBY

(75) Inventor: Guido Peleman, Antwerpen (BE)

Correspondence Address: BACON & THOMAS, PLLC, 625 SLATERS LANE, FOURTH FLOOR, ALEXANDRIA, VA, 22314-1176, US

(73) Assignee: UNIBIND LIMITED, NICOSIA (CY)

(21) Appl. No.: 12/293,856

(22) PCT Filed: Mar. 14, 2007
(86) PCT No.: PCT/IB07/00636

§ 371 Date: Sep. 22, 2008

(30) Foreign Application Priority Data
Mar. 22, 2006 (BE) 2006/0179

(51) Int. Cl. B42C 9/00

(52) U.S. Cl. 412/8

(57) ABSTRACT

Method for thermally binding a bundle of loose leaves in a binding back (4), characterised in that on a side edge (2) of the above-mentioned bundle (1) to be bound is provided a strip of melting glue (3), after which this bundle (1) is placed in the above-mentioned binding back (4) with the side edge (2) with melting glue (3) and this binding back (4) is heated so as to make the strip of melting glue (3) melt, after which the melting glue (3) is left to cool so as to bind the bundle of leaves (1) in the binding back (4).

The present invention concerns a method for binding a bundle of loose leaves and a binding element applied thereby.

In particular, the present invention concerns a method for thermally binding a bundle of loose leaves in a binding back.

Methods for thermally binding a bundle of loose leaves in a binding back are already known, whereby a strip of what is called melting glue is provided in this binding back.

By the term “melting glue” is meant a glue which melts under the influence of heat in this case.

In order to bind a bundle of leaves by means of such a binding back, this bundle of leaves is placed in the binding back, after which this binding back is heated in order to make the strip of melting glue melt, after which the melting glue is left to cool in order to make it solidify, such that the bundle of leaves is fixed in the binding back.

Although the above-mentioned known method provides excellent results, the invention aims to offer an alternative.

Moreover, this alternative method aims more flexibility when combining materials, and it also makes it possible to bind leaves for which the direct contact with the melting glue is not desirable.

To this end, the present invention concerns a method for thermally binding a bundle of loose leaves in a binding back, whereby a strip of melting glue is provided on a side edge of the above-mentioned bundle to be bound, after which this bundle is placed with the side edge with melting glue in the above-mentioned binding back, and this binding back is heated in order to make the strip of melting glue melt; the melting glue is subsequently left to cool so as to bind the bundle of leaves in the binding back.

Such a method offers an interesting alternative to the known method and moreover offers more flexibility when combining the binding back, the leaves and the glue.

According to a possible application method, the strip of melting glue is not provided directly on the above-mentioned side edge of the bundle of leaves, but by means of a binding element in the shape of an intermediary strip provided with the above-mentioned strip of melting glue on at least one side and at least over a certain strip, whereby this binding element is folded round the above-mentioned side edge with the strip of melting glue directed outward and is fixed to it, for example by means of stapling.

This offers the advantage that the melting glue does not make direct contact with the loose leaves to be bound, which may be desirable in some cases.

The invention also concerns a binding element to be applied with a method according to the invention, which binding element mainly consists of a strip of melting glue with the appropriate dimensions to be applied on the inside of a binding back.

According to a practical embodiment, the above-mentioned binding element is provided with means for fixing the above-mentioned strip of melting glue on or against the side edge of a bundle of loose leaves, for example in the form of a self-adhesive layer of glue which is covered with a removable foil, or in the form of an intermediary strip on which the strip of melting glue is fixed and which can be fixed around the edge of the bundle of leaves to be bound by means of stapling or the like.

In order to better explain the characteristics of the present invention, the following variants of a method according to the invention for thermally binding a bundle of loose leaves in a binding back and a binding element applied thereby are given as an example only without being limitative in any way, with reference to the accompanying drawings, in which:

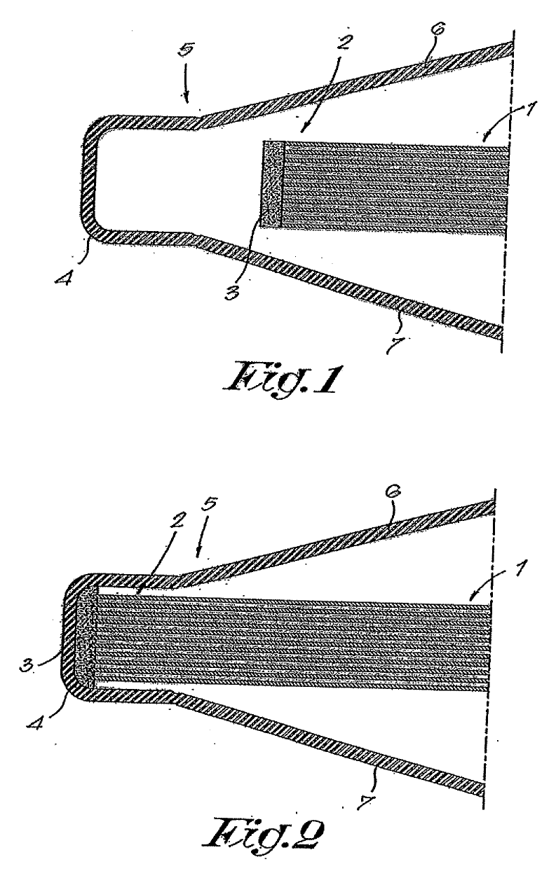

FIGS. 1 and 2 step by step represent a method according to the invention for binding a bundle of loose leaves;

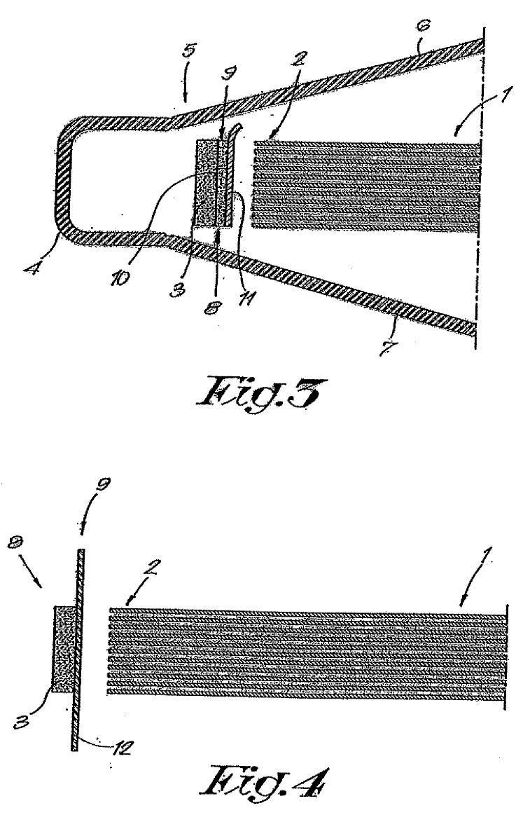

FIG. 3 schematically represents a binding element which can be applied with a method according the invention, seen as a section;

FIGS. 4 to 6 represent a variant of a method according to FIGS. 1 to 3;

FIGS. 7 to 9 represent another variant of a method according to FIGS. 1 to 3;

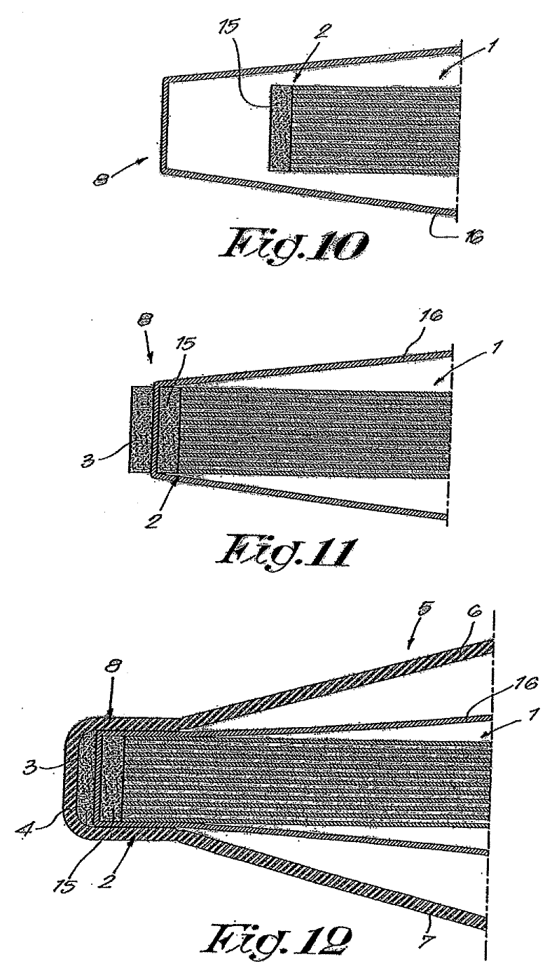

FIGS. 10 to 12 represent yet another variant of a method according to FIG. 1 to 3.

FIGS. 1 and 2 step by step represent a method according to the invention for binding a bundle of loose leaves 1.

In a first step, which is represented in FIG. 2, a strip of melting glue 3 is provided on a side edge 2 of the above-mentioned bundle of loose leaves 1 which is in this case provided directly on the above-mentioned side edge 2.

This can for example be realised by immersing this bundle of loose leaves 1 with the side edge 2 concerned in an amount of melting glue in a molten state.

After the strip of melting glue 3 has solidified at least partly, the bundle of leaves 1 is placed in the binding back 4 of a cover 5, after which the binding back 4 is heated in the known manner in order to make the strip of melting glue 3 melt.

The above-mentioned cover 5 is preferably of a known type which is provided with two rigid end leaves 6 and 7 which are hinge-mounted to the binding back 4 which is for example, but not necessarily of the type which is provided with a metal U-shaped element, not represented in the figures, which allows for a good conduction of heat.

It is clear, however, that many other materials can be used to produce the above-mentioned binding back, such as cardboard or ceramic material.

Nor must the binding back 4 necessarily be provided with end leaves 6 and 7.

When the heat source is switched off, the melting glue 3 will finally cool down and solidify, such that a bound bundle of leaves in a cover 5 is obtained, as represented in FIG. 2.

An alternative method for applying the strip of melting glue 3 on the side edge of the bundle of loose leaves 1 to be bound consists in using a binding element 8, as represented in FIG. 3.

This binding element 8 mainly consists of a strip of melting glue 3 with the appropriate dimensions to be provided on the inside of a binding back 4 and it is further provided with means 9 which make it possible to fix the above-mentioned strip of melting glue 3 on or against the side edge 2 of a bundle of loose leaves 1,

In this case, but not necessarily, the above-mentioned means 9 for fixing the strip of melting glue 3 are made in the form of a self-adhesive layer of glue 10 which is covered with a removable foil 11.

In order to bind a bundle of loose leaves 1, the above-mentioned removable foil 11 of the self-adhesive layer of glue 10 must be removed first and the strip of melting glue 3 must then be glued against the side edge 2 of the above-mentioned bundle of loose leaves 1 by means of said self-adhesive layer of glue 10.

Next, the bundle of leaves 1 with the side edge 2 concerned with melting glue 3 is put in a binding back 4 so as to be thermally bound in the known manner.

FIGS. 4 to 6 represent a variant of a method according to the invention.

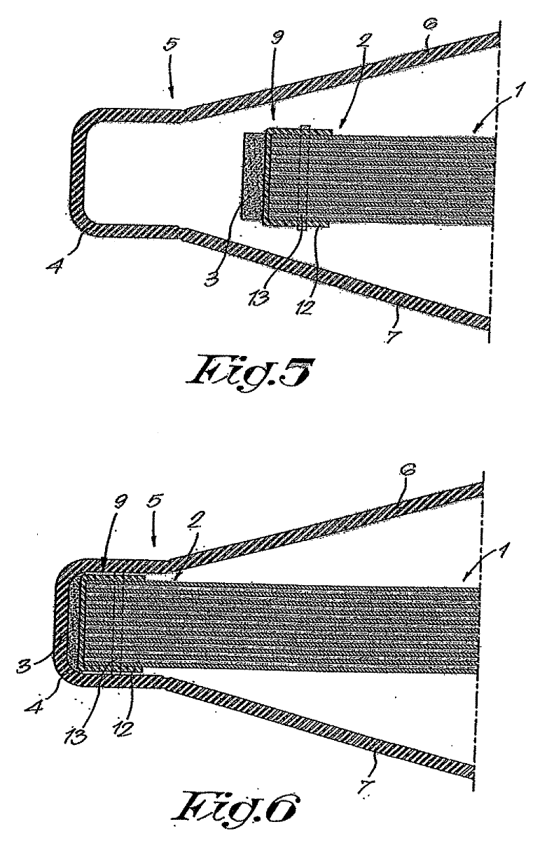

As is represented in FIG. 4, use is made of a binding element 8 as that of FIG. 3 with this method as well, but the means 9 for fixing this strip of melting glue 3 on or against the side edge 2 of a bundle 1 to be bound are in this case formed of an intermediary strip 12, for example made of paper, cardboard or the like, onto which the strip of melting glue 3 is provided on at least one side over at least a certain strip and which can be fixed around the side edge 2 of the bundle of leaves 1 to be bound by means of staples 13 or the like, as represented in FIG. 5.

A final step, represented in FIG. 6, consists in putting the bundle of leaves 1 with the binding element 8 attached to it in the binding back 4 of the cover 5 and in subsequently heating this binding back 4 so as to make the strip of melting glue 3 melt, and in finally leaving the strip of melting glue 3 to cool again so as to make it solidify, such that a bound bundle of leaves is obtained.

It is clear that the above-mentioned binding element 8 must not necessarily be made of paper, but that any other material whatsoever can be used which can be stapled.

According to a variant of a method according to the invention, use is made of a U-shaped binding element 8 made of a relatively rigid material, such as metal or hard plastic, which binding element 8 is provided with the above-mentioned strip of melting glue 3 on its back and whereby this binding element 8 is fixed to the above-mentioned side edge 2 of the bundle of loose leaves 1 by means of mechanical clamping.

According to a preferred characteristic which is not represented in the figures, before the bundle of loose leaves 1 is provided in the binding back 4, the inside of the above-mentioned binding back 4 is coated with a layer of material which adheres well in the above-mentioned strip of melting glue 3, such as for example paper.

In the examples represented in the figures, the cover 5 consists of a binding back 4 and two end leaves 6 and 7 fixed thereto, but it is not excluded according to the invention for the end leaves 6 and 7 to be made separately.

In the latter case, for example at least one end leaf 6 and/or 7 can be provided, together with the bundle of loose leaves 1, with a strip of melting glue 3 on a side edge 2 so as to be bound together with this bundle of loose leaves 1 in the binding back 4.

FIGS. 7 to 9 represent another variant of the method according to FIGS. 1 to 3, whereby in a first step which is represented in FIG. 7, the bundle of loose leaves 1 is thermally bound with its above-mentioned side edge 2 in a binding element 8 which in this case, but not necessarily, has the form of a U-shaped element, for example made of cardboard, which has either or not been pre-folded and in which has been provided a layer of melting glue 14 on the inside.

To this end, as is known, the bundle of loose leaves 1 with its side edge 2 concerned is placed in this binding element 8, after which this binding element is heated so as to make the layer of melting glue 14 melt.

Next, the melting glue 14 is left to cool again so as to make it solidify, resulting in a bundle of bound leaves 1 in a binding element 8.

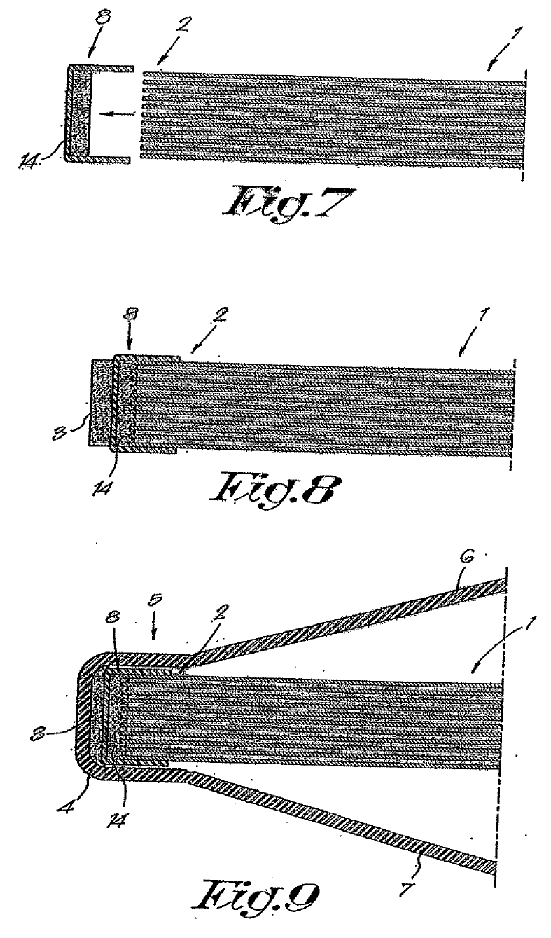

In a subsequent step which is represented in FIG. 8, a strip of melting glue 3 is provided on the outside of the above-mentioned binding element 8.

In this case, the strip of melting glue 3 is provided directly on the binding element 8, but it is clear that, according to a variant which is not represented in the figures, this can also be realised by means of an additional binding element, for example of the type which is represented in FIG. 3, which is provided with fixing means 9 in the shape of a self-adhesive layer of glue 10.

Finally, as appears from FIG. 9, the whole of the bundle of bound leaves 1 with the binding element 8 and the strip of melting glue 3 is placed in the binding back 4 of a cover 5 for thermally binding this bundle of leaves in the binding back 4.

FIGS. 10 to 12 represent yet another variant of a method according to the invention, whereby in a first step which is represented in FIG. 10, on the side edge 2 of a bundle of loose leaves 1, is provided a layer of glue 15, for example by immersing this side edge 2 in an amount of glue in a molten state.

Next, the bundle 1 is glued in a binding element 8 with its glued side edge 2 which is in this case made in the form of a leaf 16, for example made of paper, which leaf 16 can be entirely folded round the bundle of leaves 1.

It is clear that the above-mentioned binding element 8 can also be realised in other ways, such as in the form of a U-shaped element, for example made of cardboard, which can be provided around the side edge 2 to be bound and which is glued to it by means of the above-mentioned layer of glue 15.

In a following step, which is represented in FIG. 11, is provided a strip of melting glue 3 on the back side of the above-mentioned binding element 8.

Finally, as is clear from FIG. 12, the bundle 1 with the strip of melting glue 3 is thermally bound in the binding back 4 of a cover 5.

It is clear that, in a method according to FIGS. 10 to 12, use can also be made of a binding element 8 onto which a strip of melting glue 3 has been provided beforehand, such that the step from FIG. 11 can be excluded.

The present invention is by no means limited to the method given as an example and represented in the accompanying drawings; on the contrary, such a method according to the invention for thermally binding a bundle of loose leaves and a binding element applied thereby, can be made according to all sorts of variants while still remaining within the scope of the invention.

1. Method for thermally binding a bundle of loose leaves in a binding back comprising the steps:
fixing a strip of melting glue on or against a side edge of a bundle to be bound; then
if the strip of melting glue has been fixed to the side edge in a molten state, letting the strip of melting glue at least partly solidify; then
placing the side edge of the bundle with the strip of melting glue in a binding back; and then
heating the binding back so as to make the strip of at least partly solidified melting glue melt, after which the strip of melting glue is left to cool so as to bind the bundle of leaves in the binding back.

2. Method according to claim 1, wherein the strip of melting glue is fixed directly on the side edge of the bundle of loose leaves.

3. Method according to claim 1, wherein the strip of melting glue is glued against the side edge of the bundle of leaves.

4. Method according to claim 1, wherein the strip of melting glue is fixed on the side edge of the bundle of leaves by means of a binding element in the shape of an intermediary strip provided with the strip of melting glue on at least one side and over at least a certain strip, wherein the binding element is folded round the side edge with the strip of melting glue (3) directed outward and fixed to it.

5. Method according to claim 4, wherein the binding element is fixed to the bundle of loose leaves by means of stapling.

6. Method according to claim 4, wherein the binding element is fixed to the bundle of loose leaves by means of mechanical clamping.

7. Method according to claim 1, wherein the strip of melting glue is provided on the side edge of the bundle of leaves by means of a binding element in which the bundle of loose leaves is thermally bound and onto which the strip of melting glue is subsequently fixed so as to enable thermally binding the bundle of leaves in the binding back.

8. Method according to claim 1, wherein the strip of melting glue is fixed on the side edge of the bundle of leaves by gluing the side edge in a binding element and by subsequently fixing the strip of melting glue on the binding element so as to thermally bind the bundle of leaves in the binding back.

9. Method according to claim 1, wherein the strip of melting glue is fixed on the side edge of the bundle of leaves by gluing the side edge in a binding element, which binding element has been provided beforehand with the fixed strip of melting glue on its back so as to enable thermally binding the bundle of leaves in the binding back.

10. Method according to claim 1, wherein the strip of melting glue is fixed on the side edge of the bundle of loose leaves by immersing the side edge in an amount of melting glue in a molten state.
